(19) United States
(12) Patent Application Publication
(10) Pub. No.: US 2001/0010132 A1
(43) Pub. Date: Aug. 2, 2001

(54) Package with advertisement print

(76) Inventor: Ralph Deuerling, Nuremberg (DE)

Correspondence Address: David Toren, BROWN & WOOD LLP, One World Trade Center, New York, NY, 10048-0557, US

(21) Appl. No.: 09/765,139

(22) Filed: Jan. 18, 2001

(30) Foreign Application Priority Data
Jan. 27, 2000 (DE) 200 01 348.3

(51) Int. Cl. G09F 3/00

(52) U.S. Cl. 40/312; 229/939

(57) ABSTRACT

A package including a container for storing a packaged product, and a cover which forms, together with the container, a cardboard box and which is integrally connected with the container along one side of the cardboard box, with the container and/or the cover being formed of a double-face corrugated cardboard and having a cardboard sheet provided on its outer surface, which forms an outer side of the cardboard box, with a advertisement print.

### BACKGROUND OF THE INVENTION

1. Field of the Invention

The present invention relates to a package for a baked product such as, e.g., pizza, formed as a box having a container for storing the product and a cover hingedly connected with the container.

2. Description of the Prior Art

Such packages are generally known and can be provided with inscriptions made by the product manufacturer and containing instructions with respect to handling the stored product or describing the product. The package can also contain information about the package manufacturer or the package itself. The package can also be provided with an ornamental print which serves only for furnishing the package. Also known are packages with advertisements of third parties which differ form the package manufacturer, product manufacturer, and/or product or package supplier.

A known package with third parties advertisements is represented, e.g., by a plastic container for a product sold in a pharmacy, with the information printed thereon relating to some medicine or its manufacturer. These plastic containers are accessible only to a limited portion of the public. Also, these advertisements should relate to medicine products. Further, the print quality of the print provided on the plastic container is rather poor, and the creases of the container adversely affect the reading of the advertisement.

Accordingly, an object of the present invention is to provide a package with third parties advertisements characterized by high printing quality.

### SUMMARY OF THE INVENTION

This and other objects of the present invention, which will become apparent hereinafter, are achieved by forming the package as a cardboard box having a container section or container and a cover section or cover, with the cover being integrally connected with the container along one side of the cardboard box, and with the container and/or the cover being formed of a double-face corrugated cardboard and having a cardboard sheet provided on its outer surface, which forms an outer side of the cardboard box, with a advertisement print.

Forming the package box of a cardboard provides for a better quality of the print. Because box planes form relatively rigid walls, the walls offer smooth surfaces for the advertisement print. As the packaged product, such as pizza, finds an extensive demand, the third parties advertisements would be accessible to a large portion of the public. Because the cardboard used is a double-face corrugated cardboard which provides more rigid surfaces for printing, the print quality is substantially improved by combining smoothness of the cardboard sheet surface with rigidity of the double-face corrugated cardboard.

The cardboard box is primarily designed for holding a pizza, which is formed as a round disc having a backed bottom with a circumferential ledge and a layer of vegetables and/or sausages placed on the backed bottom.

The advertisement print is provided on the outer surface of the cardboard box, e.g., in th bottom region of the container. However, advantageously, the advertisement print is provided on the cover as, in this case, it is particularly visible. Preferably, the print is provided on the upper surface of the cover.

The advertisement print can generally be obtained by a conventional roller printing. However, advantageously, the advertisement print is produced or formed as a four-color halftone print. The four-color halftone print, which is formed by applying primary colors in the form of halftone dots, produces a better quality print.

It is particularly preferable and advantageous when the advertisement print is formed as a reproduction of a photographic picture. The exact reproduction of a photographic picture provides for a better print quality than printing on the cardboard.

It is further preferable and advantageous when the sheet with an advertisement print thereon is glued to the wavy paper of the core of the double-face corrugated cardboard. This permits to print the advertisement on the cardboard sheet before it is glued to the core of the double-face corrugated cardboard the container and/or the cover is (are) made of. This simplifies the manufacture of the cardboard box and permits to improve the printing process.

It is particularly preferable and advantageous when the advertisement print is obtained by the offset printing. The present invention also includes the method of producing the cardboard box according to which a cardboard sheet of the further produced double-face corrugated cardboard is provided with an advertisement print by offset printing. The offset printing can be effected as a four-color halftone printing, as a roller printing, and/or as a reproduction of a photographic picture. The offset printing insures a high quality print.

It is preferable when the advertisement print occupies the entire outer surface of the container and the cover. Providing the advertisement over the entire outer surface of the box improves its appearance and increase the effect of the advertisement.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS:

The drawings show:

FIG. 1 a plan view of a package with an advertisement print according to the present invention with a cut-out; and

FIG. 2 a cross-sectional view of a portion of the package shown in FIG. 1 at an increased scale.

### DETAILED DESCRIPTION OF THE PREFERRED EMBODIMENT

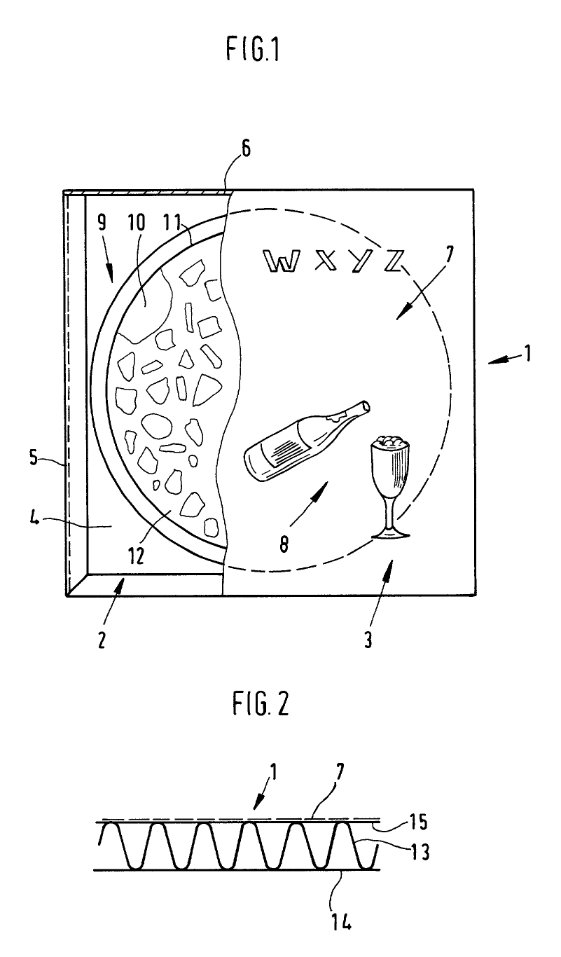

The package according to the present invention, which is shown in FIG. 1, represents a flat cardboard box 1 having a rectangular shape and essentially consisting of a container 2 and a cover 3. The container 2 has a bottom 4 and a lower wall 5 having a side 6 carrying the cover 3 hingedly connectable with the side 6. On the outer side of the cover 3, there is provided an advertisement print 7 including a picture 8 formed as photo-reproduced picture. In the cardboard box 1, there is located a pizza 9 which represents a packed product. The pizza 9 is a round disc. The pizza 9 includes a backed bottom 10 with a circumferential ledge 11, and a layer 12 provided on the bottom 10 and consisting of, e.g., vegetable and sausages.

The cardboard box 1 is formed of a corrugated cardboard, as shown in FIG. 2. The cardboard is a double-face corrugated cardboard having a core 13 formed of a wavy paper. On opposite sides of the core 13, there are provided paper sheets 14 and 15 of which the sheet 15 is provided with an advertisement print 7. The paper sheet 15 is glued to the wavy paper forming the core 13.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. A package, comprising a container for storing a packaged product; and a cover which forms, together with the container, a cardboard box and which is integrally connected with the container along one side of the cardboard box,
wherein at least one of the container and the cover is formed of a double-face corrugated cardboard and has a cardboard sheet provided on an outer surface thereof, which forms an outer side of the cardboard box, with a advertisement print.

2. A package as set forth in claim 1, wherein the at least one of the container and the cover is the cover.

3. A package as set forth in claim 1, wherein the advertisement print is formed as a four-color halftone print.

4. A package as set forth in claim 1, wherein the advertisement print is formed as a reproduction of a photographic picture.

5. A package as set forth in claim 1, wherein the advertisement print is formed by roller printing.

6. A package as set forth in claim 1, wherein the double-face corrugated cardboard has a core formed of a wavy paper, and the cardboard sheet is glued to the core.

7. A package as set forth in claim 1, wherein the advertisement print is formed by offset printing.

8. A package as set forth in claim 1, wherein both the container and the cover have an advertisement print on outer sides thereof and covering the entire outer sides of both the container and the cover.
